(19) United States
(12) Patent Application Publication
(10) Pub. No.: US 2010/0161827 A1
(43) Pub. Date: Jun. 24, 2010

(54) METHODS AND APPARATUS TO MANAGE PORT RESOURCES

(76) Inventors: Stephen J. Griesmer, Westfield, NJ (US); James Gordon Beattie, JR., Bergenfield, NJ (US); Debebe Assefa Asefa, Eatontown, NJ (US)

Correspondence Address: AT&T Legal Department - HFZ;ATTN. Patent Docketing, One AT&T Way, Room 2A-207, Bedminstor, NJ, 07921, US

(21) Appl. No.: 12/342,448

(22) Filed: Dec. 23, 2008

(51) Int. Cl. G06F 15/16

(52) U.S. Cl. 709/232

(57) ABSTRACT

Example methods and apparatus to manage port resources are disclosed. A disclosed example method includes receiving a static threshold associated with a network parameter and receiving a current value associated with the network parameter. The example method also includes invoking a first response when the current value exceeds the static threshold, when the current value does not exceed the static threshold, receiving a second threshold associated with a rate of change value of the network parameter, and invoking a second response when the rate of change value exceeds the second threshold.

### FIELD OF THE DISCLOSURE

This disclosure relates generally to customer network services and, more particularly, to methods and apparatus to manage port resources.

### BACKGROUND

Aggressive marketing for network services creates an associated market enthusiasm for one or more marketed regions. Such marketing may generate a degree of network performance expectation regarding services as well as an initial impression that the marketed services are available upon request. To meet customer performance and availability expectations, a service provider typically performs one or more forecasts for regions of interest to determine, in part, a likely demand for the services. Based on such forecasts, service providers may mobilize a workforce having a skill level and/or presence that is capable of preparing an existing network/telecommunication infrastructure for the marketed services. The workforce skill level and presence (e.g., a number of workers typically needed to accomplish implementation objective(s)) may be determined based on several factors, including whether the region of interest has a legacy infrastructure, a relatively new infrastructure, and/or a combination of legacy and new infrastructure characteristics.

Although one or more initial predictions associated with the region of interest result in a suitable workforce presence and/or skill level, such regions of interest may continue to evolve after the predictions have been made. As a result, one or more characteristics of the region of interest, when changed, may render initial predictions inappropriate for the current needs of the customer base associated with that region of interest.

### BRIEF DESCRIPTION OF THE DRAWINGS

FIG. 1 is a schematic illustration of an example communication system constructed in accordance with the teachings of this disclosure.

FIG. 2 is a schematic illustration of the example port resource manager shown in FIG. 1.

FIGS. 3A-3D are example graphical user interfaces representative of network parameters.

FIGS. 4-12 are flowcharts representative of example processes that may be performed by, for example, the example port resource manager shown in FIGS. 1 and 2.

FIG. 13 is an example port utilization table constructed in accordance with the teachings of this disclosure.

FIG. 14 is a schematic illustration of an example processor platform that may be used and/or programmed to implement any or all of the example methods and apparatus described herein.

### DETAILED DESCRIPTION

Example methods and apparatus to manage port resources are disclosed. A disclosed example method includes receiving a static threshold associated with a network parameter and receiving a current value associated with the network parameter. The example method also includes invoking a first response when the current value exceeds the static threshold and, when the current value does not exceed the static threshold, receiving a secondary threshold associated with a rate of change value of the network parameter, and invoking a second response when the rate of change value exceeds the secondary threshold.

A disclosed example apparatus includes a region interface manager to receive characteristic information from a plurality of network regions, a regional data repository to store the received characteristic information, and at least one network tracker to measure and calculate at least one rate of change associated with the received characteristic information. The example apparatus also includes a network correlator to implement a dynamic network element performance threshold based on the at least one rate of change.

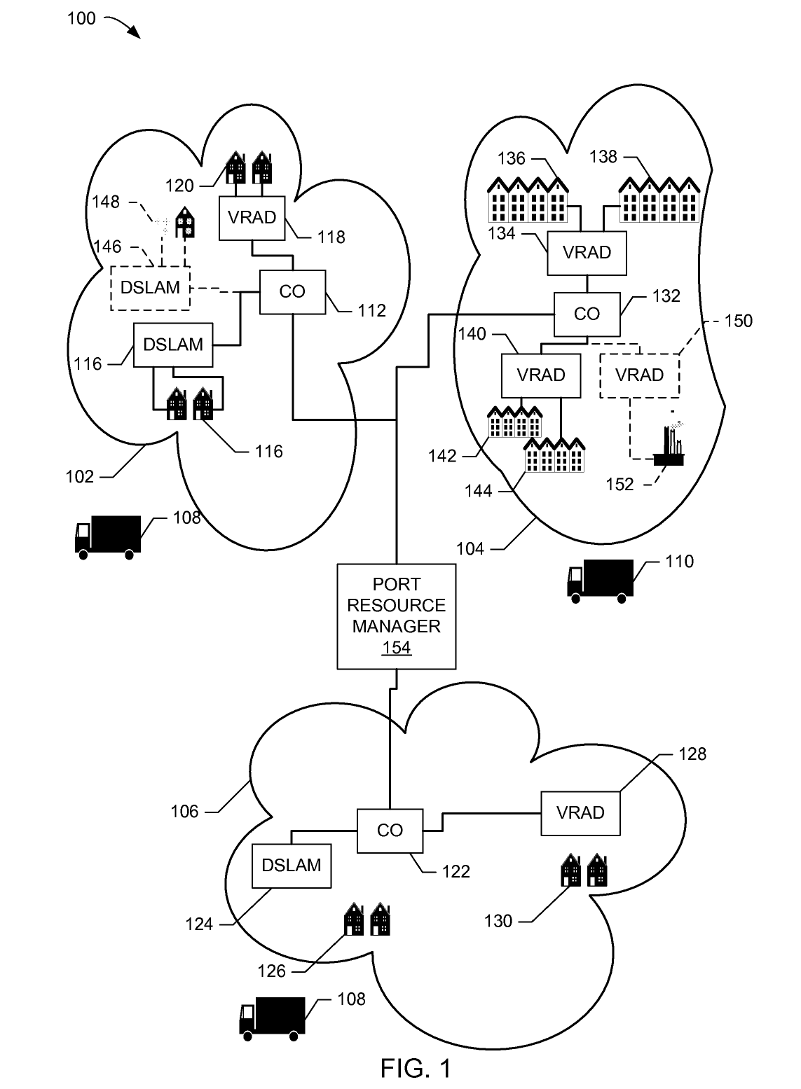

In the interest of brevity and clarity, throughout the following disclosure, references will be made to the example communication system 100 of FIG. 1. However, the methods and apparatus described herein to manage port resources are applicable to other types of systems and/or networks constructed using other network technologies, topologies, and/or protocols.

Service providers typically manage one or more regions in which telecommunication, audio, video, and/or other networking services are marketed, provided, and/or serviced to a customer base. The region may represent one or more neighborhoods, subdivisions, apartment complexes, condominiums, industrial areas and/or rural areas. Further, each region may include any combination of legacy infrastructure (e.g., bundles of twisted copper pair), or a relatively new infrastructure (e.g., bundles of fiber, video ready access devices (VRADs), etc.). Depending on the type of infrastructure within each region, one or more types of specifically trained workforce employees may be needed to properly and efficiently handle installation, service, and/or maintenance of the equipment within the region.

FIG. 1 is a schematic illustration of the example network environment 100, which includes any number and/or types of network infrastructure equipment. In the illustrated example of FIG. 1, an example service provider manages, services, and/or maintains region “A” 102, region “B” 104, and region “C” 106. Each region 102, 104, 106 includes an associated workforce comprising any number of employees (e.g., a workforce presence), each having one or more skills suitable for the region in which the employee works. Based on one or more characteristics of a region, the workforce may be specifically tailored to accommodate maintenance, installation, and/or service needs. Workforce “Z” 108 is shown in the illustrated example of FIG. 1 associated with region “A” 102 and region “C” 106. On the other hand, workforce “Y” 110 is shown in the illustrated example of FIG. 1 as associated with region “B” 104. As described in further detail below, the characteristics of region “A” 102 and region “C” 106 have one or more similarities that allow the workforce “Z” 108 to better handle maintenance, installation, and/or service needs therein, while the characteristics of region “B” 104 are better handled by the quantity and training expertise of employees associated with workforce “Y” 110.

In the illustrated example of FIG. 1, region “A” 102 includes a central office (CO) 112 communicatively coupled to a digital subscriber line access multiplexer (DSLAM) 114 that services one or more households and/or businesses 116. The example CO 112 is also communicatively coupled to a VRAD 118 that services one or more households and/or businesses 120. Similarly, region “C” 106 includes a CO 122, a DSLAM 124 to service one or more households and/or businesses 126, and a VRAD 128 to service one or more households and/or businesses 130. As shown in the illustrated example of FIG. 1, because region “A” 102 and region “C” 106 have substantially the same infrastructure, network topology, and/or other similar infrastructure characteristics, workforce “Z” 108 best accommodates the service, maintenance, and/or installation needs therein. In particular, regions “A” 102 and “C” 106 facilitate network services for neighborhoods, subdivisions, and rural areas, unlike example region “B” 104 discussed in further detail below. In view of such example differences between region “B” 104 and regions “A” 102 and “C” 106, alternate workforce employee skill levels and employee presence are required for the example region “B” 104.

In the illustrated example of FIG. 1, region “B” 104 includes a CO 132 communicatively coupled to a North VRAD 134 to facilitate one or more services for apartments 136 and condominiums 138. The example CO is also communicatively connected to a South VRAD 140 to facilitate one or more services for apartments 142 and condominiums 144. Network service implementation and maintenance for the example region “B” 104 introduces one or more engineering and/or technology challenges associated with a higher density population (e.g., apartments, condominiums, office buildings, etc.) that are not necessarily present in regions having customers that are spread-out (e.g., subdivisions, rural areas, etc.). As such, the example region “B” 104 of FIG. 1 employs workforce “Y” 110 to handle the nuances of the network topology and/or technology in region “B.”

In the illustrated example of FIG. 1, region “A” 102 includes an auxiliary DSLAM 146 that may not have been envisioned by the service provider when initially engineering the one or more resources needed for region “A” 102. In particular, the service provider was not, at the initial time for engineering resources for region “A” 102, aware of an additional subdivision 148 that resulted from the general growth and/or development of the area/community. Similarly, region “B” includes an auxiliary VRAD 150 to facilitate high-speed, high-bandwidth services for an industrial park 152 that was not in existence when the service provider was initially engineering one or more plans to deploy network resources for region “B” 104. The methods and apparatus described herein, in part, enable a service provider to manage port resources, port expansion, and/or port reduction in a timely manner. For example, one or more significant changes to the characteristics of a region may not be appreciated until the service provider is confronted with excessive service performance issues and/or service availability complaints due to high-growth, aggressive marketing for services, and/or over-commitments by the service provider in any particular region.

Each of example region “A” 102, region “B” 104, and region “C” 106 are communicatively coupled to an example port resource manager 154. In the illustrated example of FIG. 1, the port resource manager 154 couples to each region via its respective CO 112, 122, 132 to, in part, acquire characteristic information about each region 102, 104, 106. The characteristic information acquired by the example port resource manager 154 may include, but is not limited to the population of each region, the number of current subscribers in each region, the number of projected subscribers in each region, the type of infrastructure in each region, the type(s) of network element(s) (NEs) in each region, the port availability in each region, the number of bad port(s) in each region, the number of loops available in each region, the type of loops in each region (e.g., copper twisted pair, fiber, hybrid, etc.), the number of bad loop(s) in each region, and/or the type of workforce team(s) implemented in each region to accommodate the respective network infrastructure and/or network technologies in each region.

As described in further detail below, the example port resource manager 154 monitors each region for one or more network characteristics and calculates and/or measures changes that may occur in each region that may alert the service provider of potential port availability and/or service issues before customer complaints occur. For example, customer complaints typically invoke responsive action on behalf of the service provider that was previously unaware of degrading performance and/or service availability. On the other hand, the example port resource manager 154, in part, identifies a rate of change in one or more network characteristics that indicate a circumstance that, if left unaddressed, could result in negative performance experiences by one or more network subscribers. Example network changing characteristics that may result in availability and/or performance issues include, but are not limited to, a rate change in new subscribers that exceeds regional capacity, a rate of change in performance (e.g., performance degradation) that may drop below customer performance expectations, and/or a rate of change in service calls in a region that indicates systemic network infrastructure deficiencies.

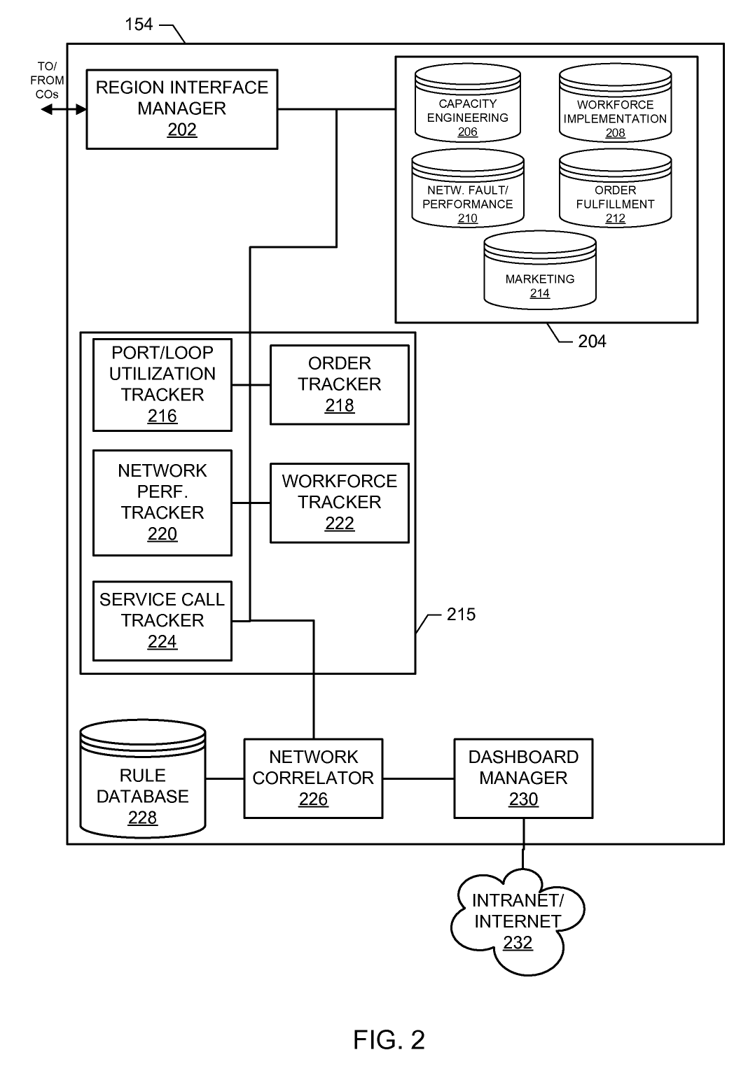

FIG. 2 is a detailed schematic illustration of the example port resource manager 154 of FIG. 1. The example port resource manager 154 includes a region interface manager 202 and a regional data repository 204 that includes a capacity engineering database 206, a workforce implementation database 208, a network fault and performance database 210, an order fulfillment database 212, and a marketing database 214. The example port resource manager 154 also includes network trackers 215, which may further include a port/loop utilization tracker 216, an order tracker 218, a network performance tracker 220, a workforce tracker 222, a service call tracker 224, a network correlator 226, a rule database 228, and a dashboard manager 230 that is communicatively coupled to an intranet or the Internet 232. In operation, the example region interface manager 202 retrieves and/or otherwise obtains characteristic information from one or more regions of interest, such as the example region “A” 102, region “B” 104, and/or region “C” 106. As described above, the characteristic information acquired by the example port resource manager 154 may include, but is not limited to engineering information, workforce information, network fault information, network performance information, service order information, and/or marketing information.

Engineering information acquired by the example region interface manager 202 may include, but is not limited to a type of infrastructure topology and/or technologies employed in the region(s), the number of disabled (bad) ports per network element in the region(s) of interest, and/or the number of disabled loops per network element in the region(s) of interest. Any such engineering information acquired by the example region interface manager 202 may be stored in the capacity engineering database 206 of the regional data repository 204. Information stored in the example capacity engineering database 206 may also include engineering plan information, such as topology schematics, design plans for providing network services in new neighborhoods, and/or design retrofit plans for upgrading one or more facets of an existing legacy and/or hybrid network.

Workforce information acquired by the example region interface manager 202 may include, but is not limited to the type and number of service personnel employed within the region(s) of interest, the type(s) of services, installations, and/or maintenance activities performed by the workforce team(s), the amount of time each activity consumed, the type(s) of specialized equipment required by the workforce team(s) to accomplish activities, a corresponding loop length associated with the service, installation, and/or maintenance activities, and/or the cable type(s) worked-on by the workforce team(s) when performing the associated service, installation, and/or maintenance activities. Any such workforce information acquired by the example region interface manager 202 may be stored in the workforce implementation database 208 of the regional data repository 204.

Network fault and performance information acquired by the example region interface manager 202 may include, but is not limited to bandwidth performance measurements per port and/or per loop for each network element in the region(s) of interest, date(s) and/or time(s) at which bandwidth measurements were taken, service calls associated with the region(s) of interest, and/or service calls associated with specific network equipment within the region(s) of interest. Any such network fault and performance information acquired by the example region interface manager 202 may be stored in the network fault and performance database 210 of the regional data repository 204.

Service ordering information acquired by the example region interface manager 202 may include, but is not limited to the number of new orders for service during a time period (e.g., the number of new orders within the last week), the number of disconnects (e.g., customers that cancel their orders) during the time period, the types of services being marketed within the region(s) of interest, a scale of any advertising/marketing promotion(s) (e.g., the amount of advertising dollars spent on the region(s) of interest), and/or a duration of any advertising/marketing promotion(s) intended for the region(s) of interest. Any such ordering and/or marketing information acquired by the example region interface manager 202 may be stored in the order fulfillment database 212 and/or the marketing database 214 of the regional data repository 204.

On a periodic, aperiodic, scheduled, and/or manual basis, each of the example port/loop utilization tracker 216, order tracker 218, network performance tracker 220, workforce tracker 222, and/or the service call tracker 224 access one or more corresponding databases within the regional data repository 204 to perform one or more calculations pertaining to one or more region(s) of interest and/or network element(s) within the region(s) of interest. For example, the port/loop utilization tracker 216 calculates a rate of change of port availability for one or more network elements in the region of interest. In the event that the network element of interest includes 100 available ports for a current time period, while the prior two time periods included 125 and 150 available ports, respectively, then the port/loop utilization tracker 216 calculates a rate of change in port utilization based on those three time periods. On the other hand, if a separate network element of interest includes 100 available ports for the current time period, while the prior two time periods also included 100 available ports, then the port/loop utilization tracker 216 calculates a rate of change in port utilization that is indicative of steady state or an absence of change. As discussed in further detail below, an indication of a rate of change in port utilization may alert service providers to a need for additional port resources (e.g., one or more additional DSLAMs, one or more additional VRADs, etc.) within a region of interest to accommodate for a rapidly growing demand for network services.

While the example port/loop utilization tracker 216 described above includes an example instance in which a network element is at steady state (e.g., no new/additional customers consuming ports of a DSLAM from one time period to the next), and an example instance in which a network element is experiencing a relatively fast changing (e.g., increasing) rate of change in utilization, the example port/loop utilization tracker 216 may also calculate a negative rate of change. For example, in the event that a region of interest is experiencing financial strain, blight, and/or if one or more housing districts are being replaced with retail establishments, then the example port/loop utilization tracker 216 may calculate a negative rate of change in port utilization as the additional available ports per network element increases. Such circumstances may alert service providers to an opportunity to redirect workforce resources to alternate location(s), scale back advertising money in an affected region, and/or redirect marketing/advertising efforts to regions having a larger potential customer base.

The example order tracker 218 also accesses the regional data repository 204 on a periodic, aperiodic, scheduled, and/or manual basis to obtain data stored in the example order fulfillment database 212. One or more rate of change calculations are performed by the example order tracker 218 to identify a rate of change in order growth, a steady state order rate, and/or a rate of change in service disconnects for one or more region(s) of interest. As discussed in further detail below, the example network correlator 226 may employ calculations from one or more of the port/loop utilization tracker 216, the order tracker 218, the network performance tracker 220, the workforce tracker 222, and/or the service call tracker 224 to determine one or more courses of action in a region of interest that maximizes service provider resources, maximizes customer performance expectations, and minimizes potential service interruptions for the customer(s).

The example network performance tracker 220 accesses one or more corresponding databases within the region data repository 204, such as the example network fault and performance database 210, on a periodic, aperiodic, scheduled, and/or manual basis to perform one or more calculations relating to regional network performance. Without limitation, the calculations may include a rate of change in bandwidth capability on a per network element and/or a per port basis. For example, the network performance tracker 220 may identify three of the most recent time periods and their associated data rates for a network element having 300 ports. In the event of an average data rate for all ports in the network element of interest for week 1 of 800 kbits/second, week 2 of 700 kbits/second, and week 3 of 500 kbits/second, the example network performance tracker 220 calculates a slope and/or other indicator of negative rate of change for those three weeks. While the service provider may guarantee a minimum example static threshold rate of 300 kbits/second for all customers, thereby not exceeding any static bandwidth rate thresholds, the above-identified rate of bandwidth decrease information may allow the service provider to address one or more imminent service interruptions and/or service availability issues based on a rapid rate of change. As such, customer complaints may be avoided if service personnel are dispatched before any static bandwidth thresholds are violated. On the other hand, the rate of decrease in average bandwidth for the ports may be indicative of excessive orders and/or advertising, which may notify the service provider of an option to stop and/or reduce marketing efforts in the region of interest.

The example workforce tracker 222 accesses one or more corresponding databases with the regional data repository 204 on a periodic, aperiodic, scheduled, and/or manual basis to categorize activities by workforce personnel on a per region, per network element, per port, and/or per loop basis. Categorization of a performed service, maintenance, and/or installation serves to, in part, appraise the service provider of corporate best practices and/or expose training, execution, and/or efficiency issues related to service personnel and/or particularly problematic network elements. Each activity performed by workforce personnel is associated with a corresponding time-to-complete metric, a list of specialized equipment employed to complete the activity, a categorization of the type of infrastructure environment in which the personnel completed the activity (e.g., legacy copper twisted-pair, fiber, hybrid, etc.), and/or a categorization of the number of ports associated with the activity (e.g., high-port density apartment environment, low-port density subdivision environment, etc.). Such information may further be utilized by the service provider as a function of engineering expansion plans for one or more future network service regions to be managed by the service provider. In other words, historical service, maintenance, and/or installation data may be used to develop engineering plans related to needed equipment, skill levels, and forecasted times to complete an expansion objective.

The example service call tracker 224 accesses one or more corresponding databases with the regional data repository 204, such as the example network fault and performance database 210, on a periodic, aperiodic, scheduled, and/or manual basis to, in part, calculate a rate of change in service calls per region, per network element, per port, and/or per loop. An increase in the rate of service calls and/or the rate of change in service calls may be indicative of excessive demand, excessive advertising beyond current infrastructure capabilities, an aging legacy infrastructure, and/or problematic network element operation and/or configuration. For example, a relatively high service call rate in a region of interest that employs relatively new network elements and/or relatively new network element technologies may expose the underlying vulnerability of a legacy copper twisted-pair infrastructure that warrants upgrade resources.

The example network correlator 226 analyzes network element utilization metrics, order rates, network element performance metrics, and/or service call rates in view of one or more static thresholds, which may be stored in the example rule database 228. For example, in the event that a network element having a total of 24 channels has 20 currently utilized channels, then the network correlator 226 generates a notification message to the service provider requesting that one or more auxiliary network elements be installed in the region of interest to accommodate additional subscribers/customers when the last four channels are utilized. As such, the static threshold may allow service providers to take preventative action prior to allowing customers to experience a denial of service based on a lack of available ports. On the other hand, static thresholds are not typically invoked when a network element is utilized less than 50%. For example, in the event that a network element having a total of 24 channels has 10 currently utilized channels, then a static threshold that triggers on 20 or more utilized channels will not be exceeded.

In some circumstances, however, a rate of change in channel utilization may provide additional insight to the service provider that results in taking preventative action despite the relatively low utilization value of 50% or less. For example, a value of utilization of 25% after initially installing a network element (e.g., a DSLAM) in a region or area (e.g., a neighborhood, an office complex, an apartment, etc.) may be indicative of moderate to low growth. Such moderate to low growth may be observed when measuring the utilization of the newly installed network element for one or more subsequent weeks, thereby exposing a rate of increase in utilization for that particular network element. On the other hand, an initial value of utilization of 50% or higher may be indicative of high growth, in which one or more subsequent weeks are likely to result in a utilization increase to 80-90% in a relatively short period of time. Such initial utilization values may reflect market enthusiasm for the products and/or services offered by the service provider. Thus, while a static threshold value may fail to allow the service provider to react to such enthusiasm, a threshold based on a rate of change in utilization may allow the service provider to implement auxiliary network elements before customers are denied service due to a lack of available ports. In operation, if the first week utilization value is 50%, and the subsequent week utilization value is 75%, then the example network correlator 226 calculates a 50% rate of change from the first to the second week, thereby indicating significant potential for reaching full capacity in a relatively short period of time. On the other hand, if the first week utilization value is 50%, and the subsequent week utilization value is 55%, then the example network correlator 226 calculates a 10% rate of change from the first to the second week, thereby indicating an absence of any urgency that the network element will be fully utilized in a relatively short period of time. Although the foregoing was described as an example containing two weeks, any number of time periods may be, additionally or alternatively, used.

Results calculated by the network correlator 226 are provided to the example dashboard manager 230 to generate one or more dashboard graphics and/or reports to the service provider. Without limitation, results calculated by the example network correlator 226 may be used alone, or in any combination with information stored in the regional data repository 204 to, for example, plan and/or adjust engineering blueprints, augment workforce presence in one or more regions, augment marketing and/or advertising plans, and/or update one or more network elements to accommodate for increasing/decreasing demand. Dashboard graphics and/or reports may be accessed by one or more administrators, employees, and/or engineers employed by the service provider via an intranet and/or the Internet 232.

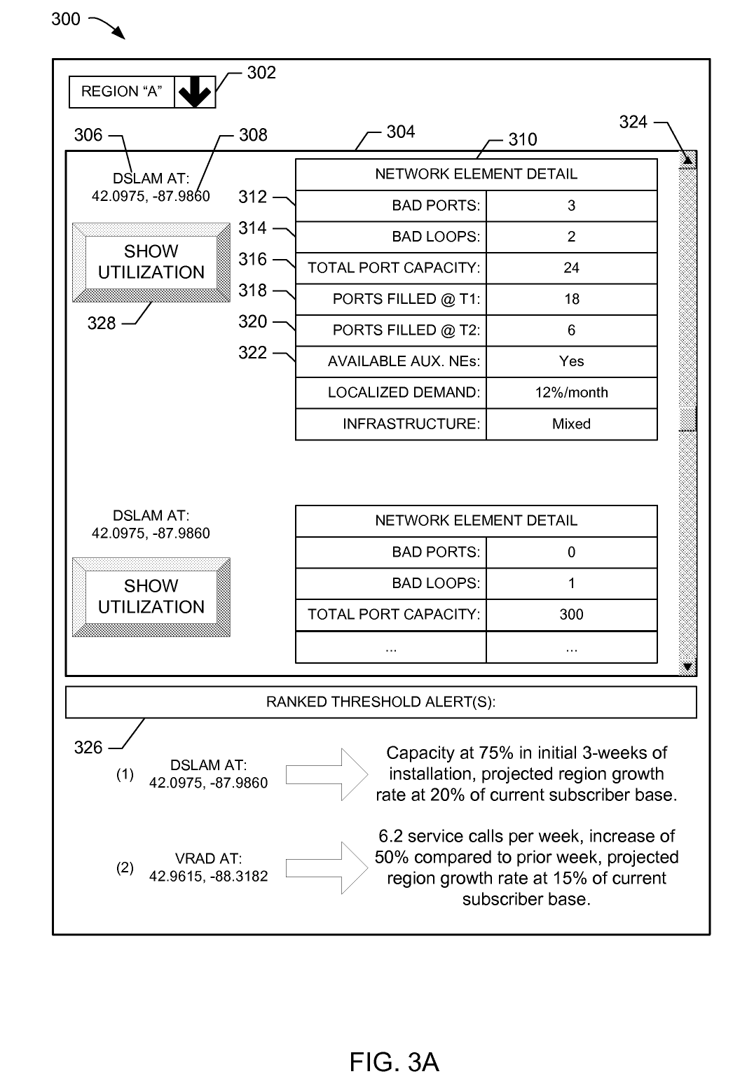

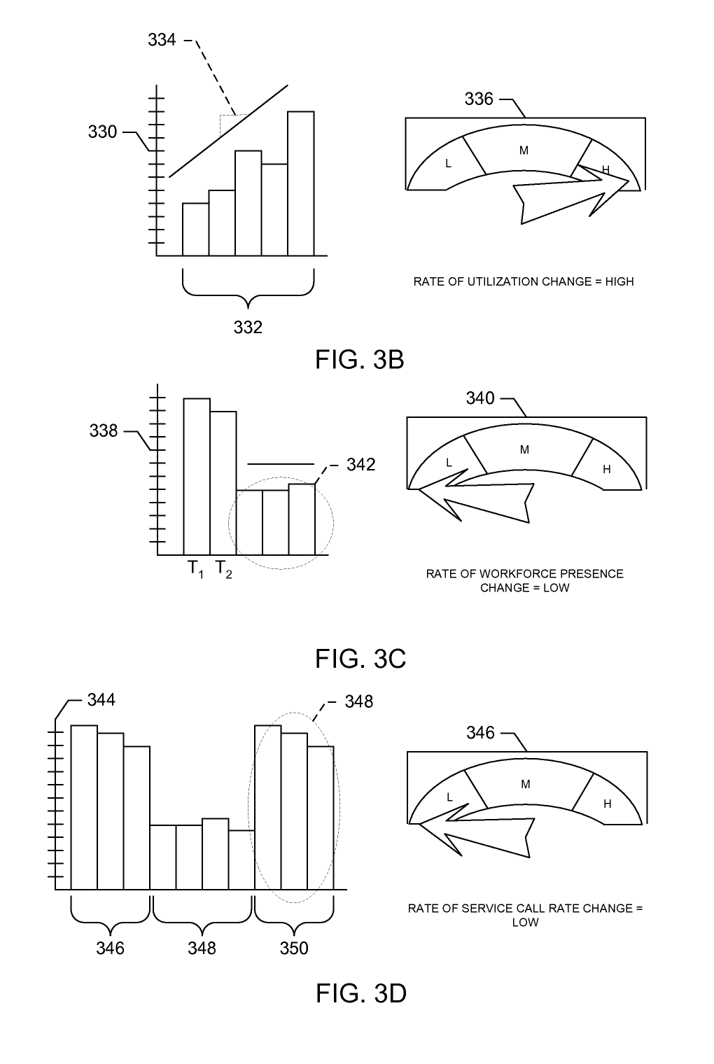

In the illustrated example of FIG. 3A, a graphical user interface (GUI) 300 provides one or more users (e.g., a service provider administrator, manager, engineer, etc.) with information relating to utilization, demand, and/or other regional parameters of interest. The user may select a region of interest via a region selection box 302 to display information related to any region of interest, such as the example region “A” 102, region “B” 104, and/or region “C” 106. An example network element viewing window 304 provides the user with information relating to each network element that resides in the selection region of interest. In the illustrated example of FIG. 3A, a DSLAM is identified 306 as operating in a specific geographic latitude and longitude 308. Corresponding detail associated with the DSLAM 306 is provided to the user in network element detail columns 310 that are tailored to the corresponding type of network element. For example, the network element detail column 310 identifies a corresponding number of bad ports 312, bad loops connected to the DSLAM 314, a total port capacity for the DSLAM 316, the number of ports filled in a first time period 318, and a number of ports filled in a second time period 320. As described above, tracking and/or acquiring port utilization based on a particular date and/or time allows a rate of change in utilization to be calculated. In the event that a network element is fully utilized (e.g., all 24 ports are consumed by subscribers), then the example GUI 300 may identify whether auxiliary network elements are present 322 within the selected region of interest to accommodate for additional subscribers in the future. Users of the example GUI 300 may select a scroll-down window 324 to review information pertaining to other network elements of the selected region of interest.

In the illustrated example of FIG. 3A, the GUI 300 presents the user with one or more ranked threshold alerts 326 that were generated by the example network correlator 226 based on one or more static thresholds, thresholds associated with rates of change, and/or thresholds that are set and monitored as a result of interdependent network characteristics. In other words, despite an example network element having only 65% utilization in which a rate of change is zero (i.e., there are no observed subscriber adds or deletions for one or more time periods), information from the example order tracker 218 may reveal that the region in which the network element is located has an expected order increase of 75% based on marketing/advertising initiatives to be rolled out in the near future. As such, the example network correlator 226 may employ interdependent thresholds to appraise service providers of potential service issues and/or network port availability issues before they cause a negative customer experience, thereby allowing the service provider to ramp-up workforce presence in the region of interest.

The example GUI 300 of FIG. 3A also includes a user-selectable button to show one or more additional utilization graphs 328. In the event that the user selects the show utilization button 328, one or more example graphs such as those shown in FIGS. 3B, 3C, and 3D may be provided to the user. Turning to FIG. 3B, an example utilization slope graph 330 is shown having one or more vertical placeholders 332 to indicate a utilization capacity of the network element at different times. The example utilization slope graph 330 also includes a slope graphic 334 to indicate a rate of change of the vertical placeholders 332 over time. An example utilization dashboard 336 may be shown to allow the user to quickly identify that a rate of change is high for the time period(s) identified by the example placeholders 332.

Without limitation, a user that selects the example button 328 to show one or more additional utilization graphs may be presented with an example workforce presence slope graph 338, as shown in FIG. 3C. An example workforce dashboard 340 is also shown in FIG. 3C, and indicates that, for the time period 342, the corresponding rate is low. However, because the user can see both graphs simultaneously, a better appreciation of potential trending can be seen by a drop in workforce presence when compared with two initial time periods T₁ and T₂. Such a drop in workforce presence may be due to, for example, efforts required by workforce personnel during initial service feature installation in the region of interest.

FIG. 3D also shows an example slope graph 344 and a dashboard graphic 346 pertaining to workforce presence. In the illustrated example of FIG. 3D, the workforce presence slope graph 344 spans a seasonal time frame from spring/summer 346 to fall/winter 348, and back to a subsequent spring/summer 350. While the dashboard graphic 346 illustrates a relatively low rate of change corresponding to the fall/winter 348 timeframe (dashed lines), the slope graph 344 helps the user to identify a potential trend in workforce needs. For example, the relative dip in workforce presence observed during the fall/winter timeframe 348 may be due to cooler temperatures in the utility boxes that house network element equipment, such as racks of DSLAMs, racks of VRADs, etc. However, during the spring and summer months, temperatures in the utility boxes may reach higher levels that result in increased service calls to replace and/or repair network equipment damaged by excessive heat. As such, user observation of such potential trends may allow preventative maintenance procedures to be employed that minimize service calls, such as installation of more robust air conditioning units within the utility boxes that enclose the network elements.

While the example network environment 100 has been illustrated in FIG. 1, one or more of the interfaces, data structures, elements, processes, GUIs, and/or devices illustrated in FIGS. 1, 2, 3A, 3B, 3C, and 3D may be combined, divided, re-arranged, omitted, eliminated and/or implemented in any other way. Further, the example port resource manager 154, the example region interface manager 202, the example regional data repository 204, the example capacity engineering database 206, the example workforce implementation database 208, the example network fault and performance database 210, the example order fulfillment database 212, the example marketing database 214, the example port/loop utilization tracker 216, the example order tracker 218, the example network performance tracker 220, the example workforce tracker 222, the example service call tracker 224, the example network correlator 226, and/or the example rule database 228 of FIGS. 1, and 2 may be implemented by hardware, software, firmware and/or any combination of hardware, software and/or firmware. Thus, for example, any or the example port resource manager 154, the example region interface manager 202, the example regional data repository 204, the example capacity engineering database 206, the example workforce implementation database 208, the example network fault and performance database 210, the example order fulfillment database 212, the example marketing database 214, the example port/loop utilization tracker 216, the example order tracker 218, the example network performance tracker 220, the example workforce tracker 222, the example service call tracker 224, the example network correlator 226, and/or the example rule database 228 may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example port resource manager 154, the example region interface manager 202, the example regional data repository 204, the example capacity engineering database 206, the example workforce implementation database 208, the example network fault and performance database 210, the example order fulfillment database 212, the example marketing database 214, the example port/loop utilization tracker 216, the example order tracker 218, the example network performance tracker 220, the example workforce tracker 222, the example service call tracker 224, the example network correlator 226, and/or the example rule database 228 are hereby expressly defined to include a tangible medium such as a memory, a digital versatile disc (DVD), a compact disc (CD), etc. storing the firmware and/or software. Further still, a communication system may include interfaces, data structures, elements, processes and/or devices instead of, or in addition to, those illustrated in FIGS. 1 and 2 and/or may include more than one of any or all of the illustrated interfaces, data structures, elements, processes and/or devices.

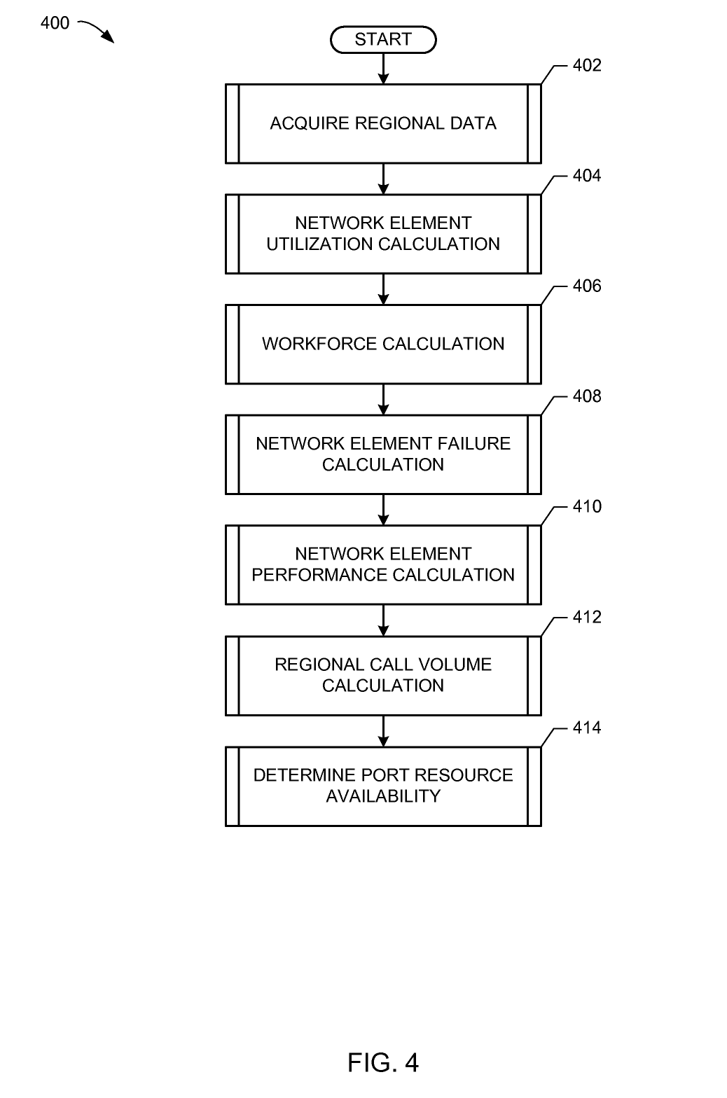

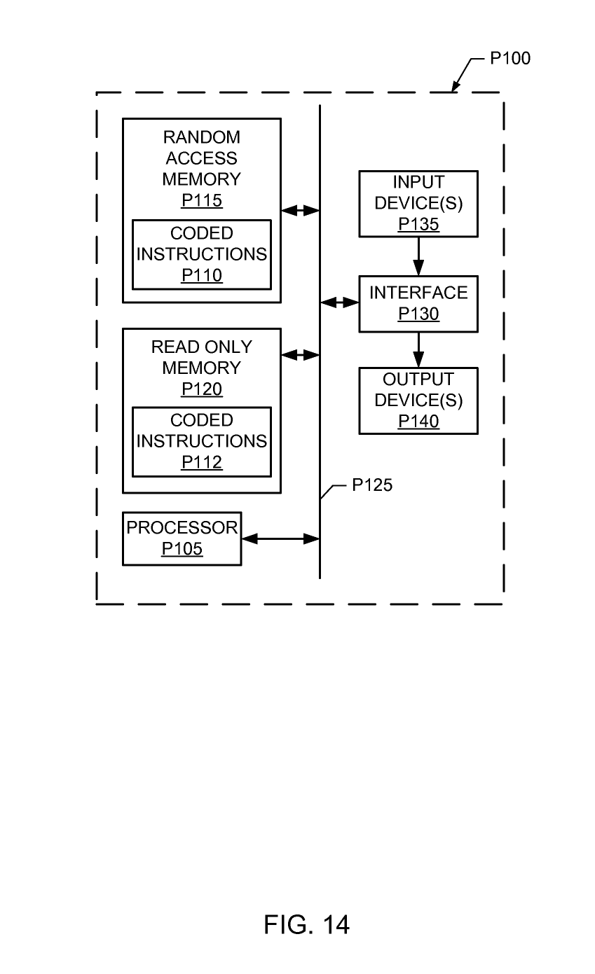

FIGS. 4-12 illustrate processes that may be performed to implement the example port resource manager of FIGS. 1 and 2. The example processes of FIGS. 4-12 may be carried out by a processor, a controller and/or any other suitable processing device. For example, the example processes of FIGS. 4-12 may be embodied in coded instructions stored on any tangible computer-readable medium such as a flash memory, a CD, a DVD, a floppy disk, a read-only memory (ROM), a random-access memory (RAM), a programmable ROM (PROM), an electronically-programmable ROM (EPROM), and/or an electronically-erasable PROM (EEPROM), an optical storage disk, an optical storage device, magnetic storage disk, a magnetic storage device, and/or any other medium which can be used to carry or store program code and/or instructions in the form of machine-readable instructions or data structures, and which can be accessed by a processor, a general-purpose or special-purpose computer, or other machine with a processor (for example, the example processor platform P100 discussed below in connection with FIG. 14). Combinations of the above are also included within the scope of computer-readable media. Machine-readable instructions comprise, for example, instructions and/or data that cause a processor, a general-purpose computer, special-purpose computer, or a special-purpose processing machine to implement one or more particular processes. Alternatively, some or all of the example processes of FIGS. 4-12 may be implemented using any combination(s) of ASIC(s), PLD(s), FPLD(s), discrete logic, hardware, firmware, etc. Also, one or more of the example processes of FIGS. 4-12 may instead be implemented manually or as any combination of any of the foregoing techniques, for example, any combination of firmware, software, discrete logic and/or hardware. Further, many other methods of implementing the example operations of FIGS. 4-12 may be employed. For example, the order of execution of the blocks may be changed, and/or one or more of the blocks described may be changed, eliminated, sub-divided, or combined. Additionally, any or all of the example processes of FIGS. 4-12 may be carried out sequentially and/or carried out in parallel by, for example, separate processing threads, processors, devices, discrete logic, circuits, etc.

The example process 400 of FIG. 4 begins with the example region interface manager 202 operating on a periodic, aperiodic, scheduled, and/or manual basis acquiring regional information (block 402). As described above, regional information may include, but is not limited to, information related to network engineering details (e.g., types of network elements, utilization of each network element, manufacturer/model numbers of each network element, infrastructure type, etc.), workforce implementation details (e.g., the number of employees available in the region for installation, service, and/or maintenance, the employee skill required for the region, the types of repair, service, and/or installation activities performed, the time taken to complete repair, service, and/or installation activities, etc.), network fault and performance details (e.g., network element performance data, service calls, etc.), order fulfillment details (e.g., number of requests for new service in the region, number of dropped customers in the region, etc.), and/or marketing/advertising plans for the region.

Based on the data acquired by the example region interface manager 202 (block 402), the example port/loop utilization tracker 216 calculates one or more utilization rates for one or more network elements of interest (block 404), the example workforce tracker 222 categorizes workforce activity for the region of interest (block 406), the example network performance tracker 220 calculates failure characteristics (block 408) and performance characteristics (block 410) for each network element, and the example order tracker 218 calculates one or more rates of order volume for each region of interest (block 412). Calculations and/or determined rates of change may be saved to one or more databases in the regional data repository 204 for use with the network correlator so that static thresholds, rate-based thresholds, and/or interdependent thresholds may be employed to determine port resource availability (block 414).

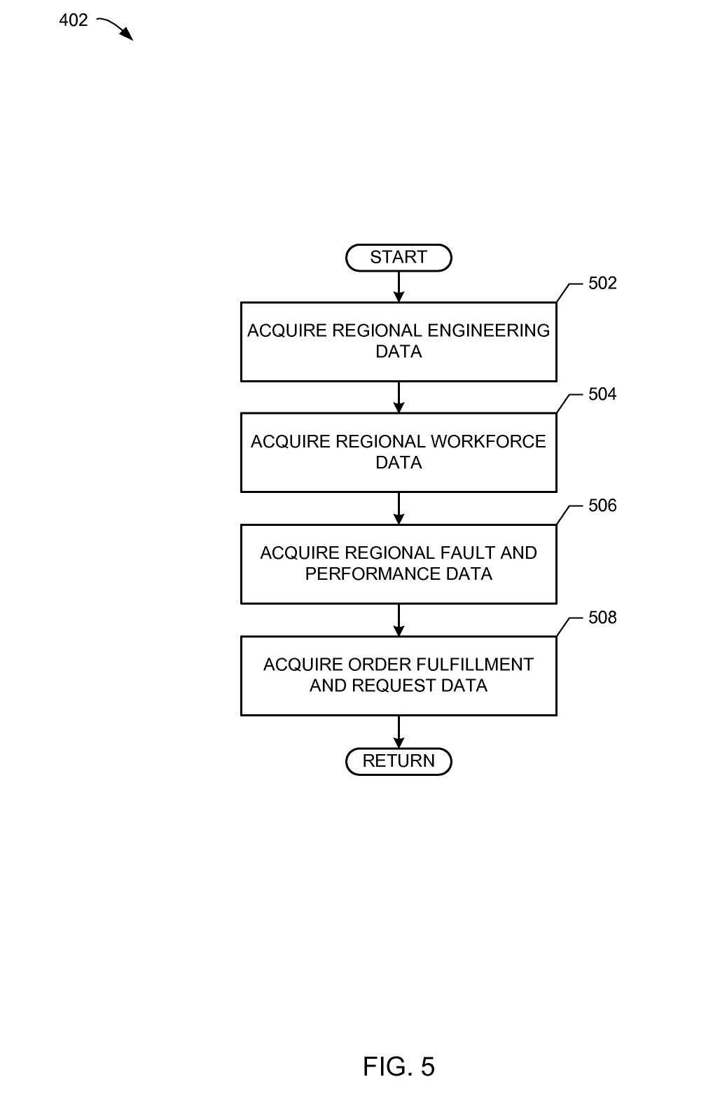

Turning to FIG. 5, the example region interface manager 202 acquires regional information from one or more regions of interest (block 402). In particular, the example region interface manager 202 acquires regional engineering data and saves it to the example capacity engineering database 206 (block 502). Information acquired may include, but is not limited to a quantity of ports per region, a quantity of ports per network element, a type of network infrastructure, a number of utilized ports per network element, and/or a number of available spare network elements and/or available refurbished network elements in the region of interest. The example region interface manager 202 also acquires regional workforce information (block 504). As described above, the acquired data is saved to the workforce implementation database 208 and may include, but is not limited to, the workforce activities performed by service personnel, the amount of time consumed by service personnel to complete one or more assigned activities, the requisite skills needed by service personnel, and/or the number of available service personnel within the region of interest. Regional fault and performance data is also acquired by the region interface manager 202 (block 506). Example fault information may include, but is not limited to service calls per region of interest, and/or service calls per network element. Example performance information may include, but is not limited to one or more bandwidth values on a daily basis and/or an hourly basis. Order fulfillment and/or order request information is acquired by the example region interface manager 202 and saved to the order fulfillment database 212 and/or the marketing database 214 (block 508). In particular, a number of new subscribers is acquired to determine, in part, whether the region of interest is capable of accommodating such new subscribers in view of existing network element port utilization values and/or corresponding rates of change.

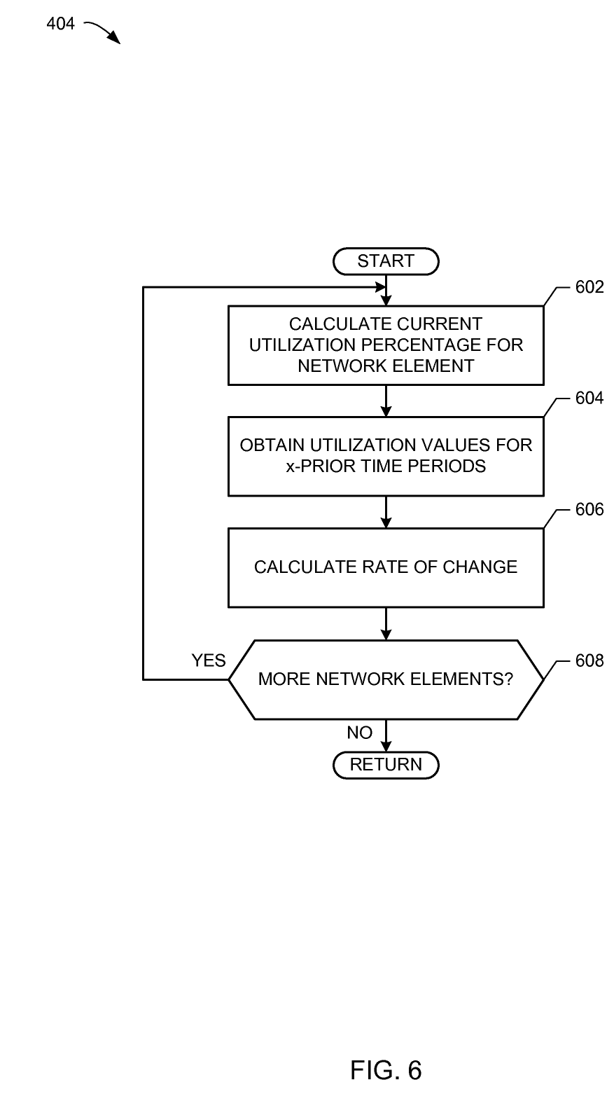

Turning to FIG. 6, the example port/loop utilization tracker 216 performs one or more calculations to determine network element utilization (block 404). In particular, the example port/loop utilization tracker 216 identifies a network element in the region of interest and calculates a current percent utilization (block 602). For example, if the network element has 24 ports, and only 20 out of 24 are utilized for servicing subscribers, then the example port/loop tracker 216 determines that the identified network element is 83% utilized. Additionally, the tracker 216 obtains utilization values (e.g., 15 out of 24 ports) from any number of prior time periods (block 604) so that a rate of change may be calculated (block 606). If additional network elements in the region of interest are present (block 608), control returns to block 602, otherwise the example process to calculate network element utilization rates (block 404) returns.

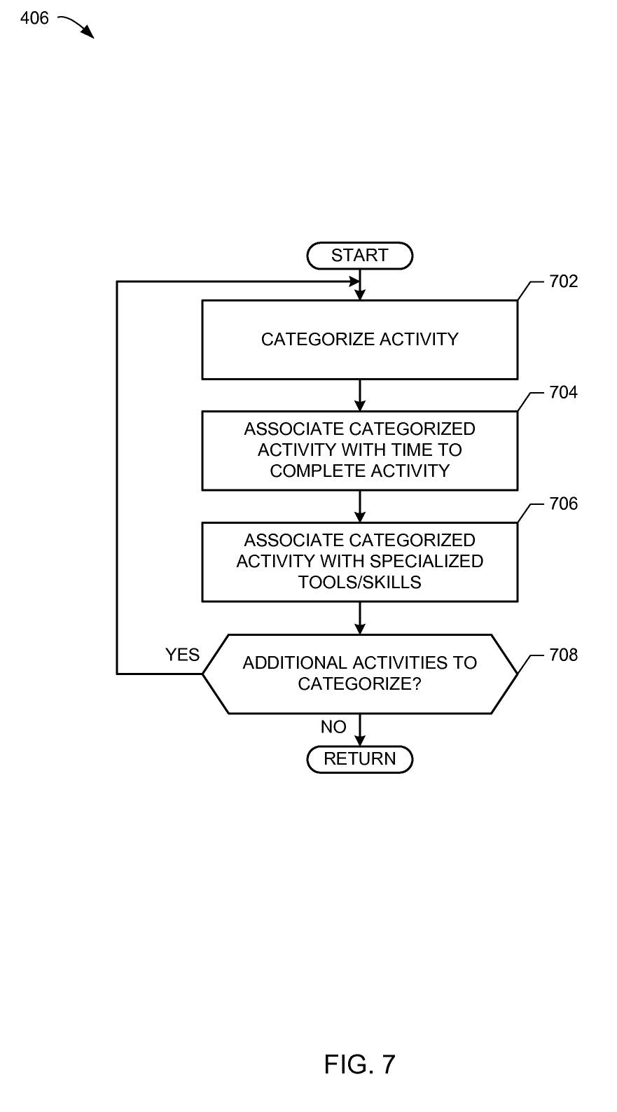

Turning to FIG. 7, the example workforce tracker 222 performs one or more instances of workforce activity categorization (block 406). In particular, the example workforce tracker 222 categorizes an activity based on one or more lists of activity types (block 702), such as activity category types of a list or lookup table. Category types may include, but are not limited to network element activities, network element activities based on infrastructure type, and/or network element activities based on a type of residence and/or business. Example category identifiers include “DSLAM installation on legacy infrastructure,” “DSLAM installation on fiber infrastructure,” “DSLAM installation on hybrid infrastructure,” “DSLAM card-swap on legacy infrastructure,” and/or “DSLAM installation on fiber apartment building.”

Each categorized activity is associated with characteristics exhibited during the activity, such as associating the activity with a time to complete (block 704) and associating the activity with details related to specialized tools, equipment, and/or training needed to complete the activity (block 706). For example, if the categorized activity is identified as “DSLAM installation on legacy infrastructure in semi-rural subdivision,” then at least one specialized piece of equipment may include a service truck with a bucket-lift to allow the service personnel to work on telephone poles. On the other hand, if the categorized activity is identified as “DSLAM installation on legacy infrastructure in urban apartment building,” then at least one specialized piece of equipment may include an air conditioning unit for utility boxes that typically enclose network elements in urban areas. If additional activities reside in the example workforce implementation database 208 that have not been categorized (block 708), then control returns to block 702. Iterations through the workforce activity categorization process (block 406) allow the service provider to develop corporate best-practices and log empirical data used for workforce planning purposes.

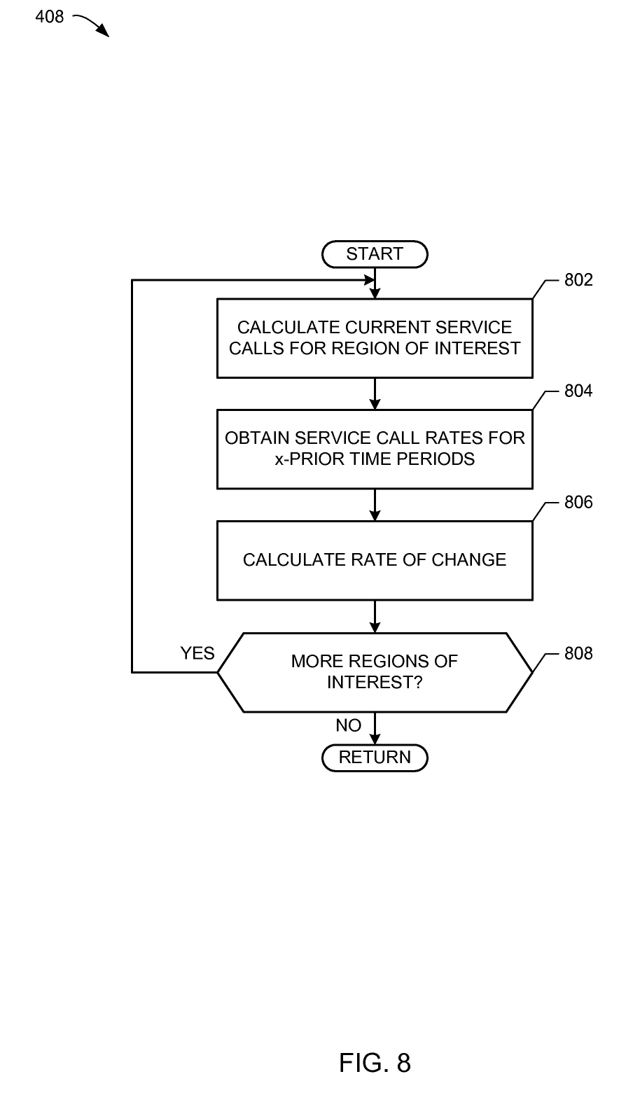

Turning to FIG. 8, the example service call tracker 224 performs one or more calculations to determine failure characteristics for a region of interest (block 408). In particular, the example service call tracker 224 identifies a number of current service calls in the region of interest for the current time period (block 802). Additionally, the example service call tracker 224 obtains service call volumes for the region of interest for any number of prior time periods (block 804) so that a rate of change in service call activity can be calculated (block 806). An increase in service call rates may be indicative of any number of factors, most of which likely require engineering and/or service personnel efforts for resolution. For example, a legacy network may experience a relatively large number of service calls for a given volume of subscribers due to an inability to accommodate sufficient expected bandwidth, while a fiber network may allow a relatively greater number of subscribers before service degradation is observed. The methods and apparatus described herein may allow benchmarks to be determined that limit the number of subscribers allowed based on the type of network infrastructure and/or based on the type of network elements employed in any given infrastructure. Such benchmarks may further be compared against marketing and/or advertising plans before such plans are initiated to confirm whether the one or more regional network(s) can accommodate expected demand. If additional regions of interest are in need of analysis (block 808), control returns to block 802, otherwise control returns to the process 400 of FIG. 4.

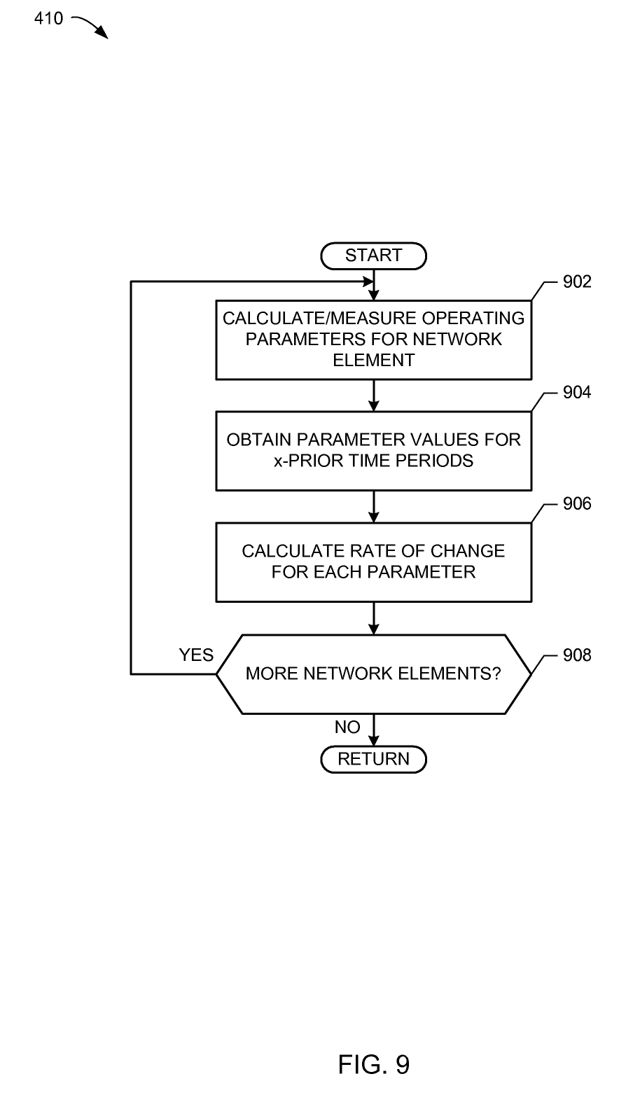

Turning to FIG. 9, the example network performance tracker 220 performs one or more measurements to determine operating and/or performance characteristics of one or more network elements in a region of interest (block 410). In particular, the example network performance tracker 220 measures current operating and/or performance characteristics (block 902), which may include, but are not limited to upload speed measurements, download speed measurements, latency measurements on one or more loops from one or more ports, and/or the time at which such measurements were taken. Knowledge of the time such measurements were taken helps to make meaningful comparisons of operating and/or performance characteristics in view of varying demands of network resources based on the time of day (e.g., heavier use during business hours versus moderate use during evening hours). Additionally, the example network performance tracker 220 obtains operating and/or performance measurement values from one or more previous time periods (block 904) so that a rate of change for each operating and/or performance metric can be calculated (block 906). A decrease in operating and/or performance characteristics may be indicative of network saturation (i.e., adding an excessive amount of subscribers to a network such that performance degradation occurs). If additional network elements of interest are in need of measurement (block 908), control returns to block 902, otherwise control returns to the process 400 of FIG. 4.

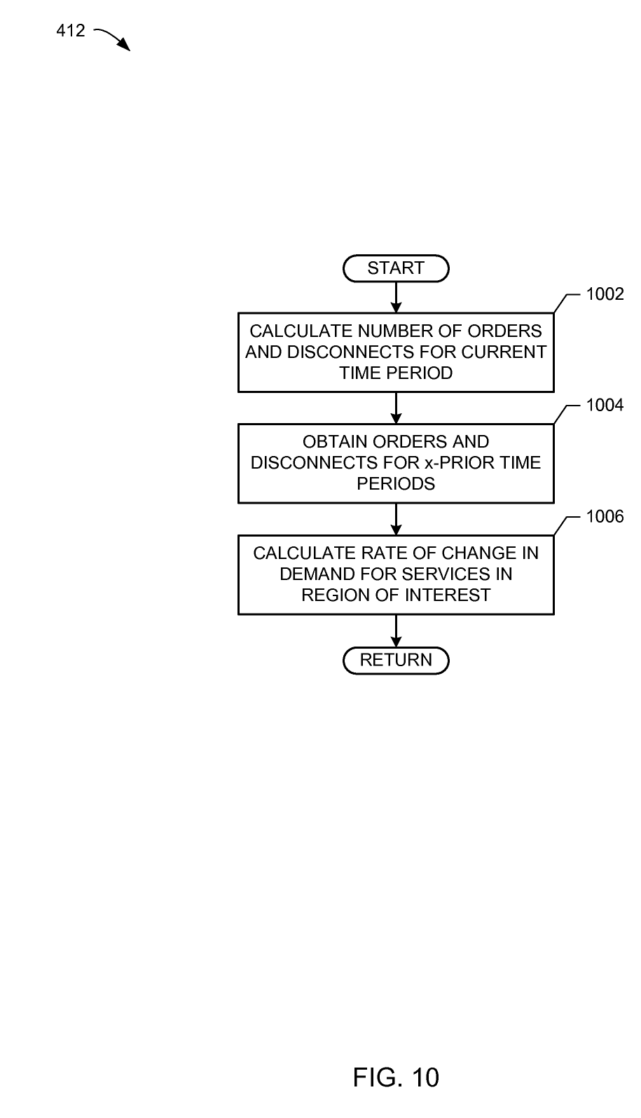

Turning to FIG. 10, the example order tracker 218 performs one or more measurements to determine regional service order demands (block 412). In particular, the example order tracker 218 measures current placed orders for the region of interest (block 1002), which may include new orders and disconnects (i.e., customers that have canceled service with the service provider). Additionally, the example order tracker 218 obtains new order and disconnect values from one or more previous time periods (block 1004) so that a rate of change for orders and/or disconnects can be calculated (block 1006). Control then returns to the process 400 of FIG. 4.

Determining port resource availability (block 412) may be accomplished by the methods and apparatus described herein via rate-based analysis and/or via influence-based analysis with interdependent thresholds. Generally speaking, the rate-based analysis considers one or more rates of change with respect to time rather than a static threshold value that may be exceeded. On the other hand, influence-based analysis considers circumstances in which a static threshold dictates a course of action when violated (e.g., install additional network elements, send a service crew, scale-back an advertising campaign for a saturated market, etc.), but such thresholds are tailored in view of influences by one or more alternate network characteristics. In other words, influence-based thresholds are not determined as an all or nothing function, but are calculated as a function of any combination of network changes that may occur over time. Such changes include, but are not limited to, an increase/decrease in customer demand for services, network port availability, network element malfunctions, network infrastructure types, neighborhood changes (e.g., new apartment complexes competing for bandwidth in a network region), etc.

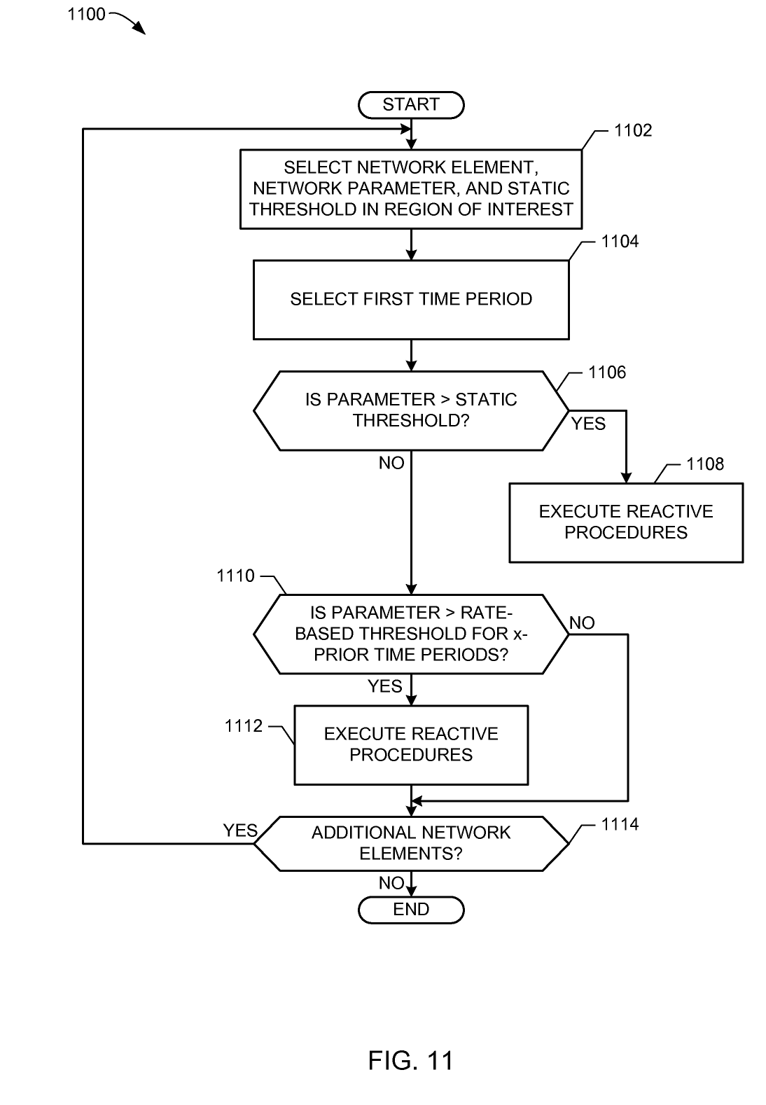

Turning to FIG. 11, an example rate-based analysis 1100 begins by the network correlator 226 selecting a network element of interest, a network parameter of interest, and an associated static threshold (block 1102). A first time period is selected (block 1104), which may represent, for example, the time in which a new network element was installed in a recently completed condominium. Before determining whether a rate-based threshold has been exceeded, the example analysis 1100 determines whether any parameter of the network element of interest in the region of interest has surpassed any static thresholds (block 1106), such as a static threshold that instructs a workforce team to add auxiliary network elements (e.g., one or more DSLAMs, one or more VRADs, etc.) when the network element reaches 90% utilization (e.g., 90 out of 100 available ports consumed by subscribers). If such a static threshold is exceeded (block 1106), then the example network correlator 226 causes such reactive procedures to be executed (block 1108), such as sending a service crew on-site. However, if no static threshold is exceeded (block 1106), the example network correlator 226 determines whether the parameter of interest (e.g., port utilization) exceeds a rate-based threshold in view of one or more prior time periods (block 1110). For example, if at a first time period a new network element having 100 available ports is installed at the example condominium and only 18 ports are utilized in the first week, then the static threshold of 90% utilization is not exceeded. However, if during the second week an additional 25 ports are consumed by network subscribers obtaining network services, then a corresponding rate of change in port utilization is relatively large (i.e., 38% jump in one week). As such, if the rate of change threshold is 25%, then the above example results in the example network correlator 226 providing one or more messages to an administrator of the network to install one or more auxiliary network elements (block 1112) under the expectation that the rate of change is indicative of significant future sales and corresponding network port utilization. Without limitation, reactive procedures may also include modifying engineering plans slated for new neighborhoods and/or regions slated for network retrofit activities. In other words, the sudden and/or unexpected changes occurring in one network region may provide foresight to the service provider when developing and/or maintaining other network regions. In the event that additional network elements remain to be analyzed, control returns to block 1102.

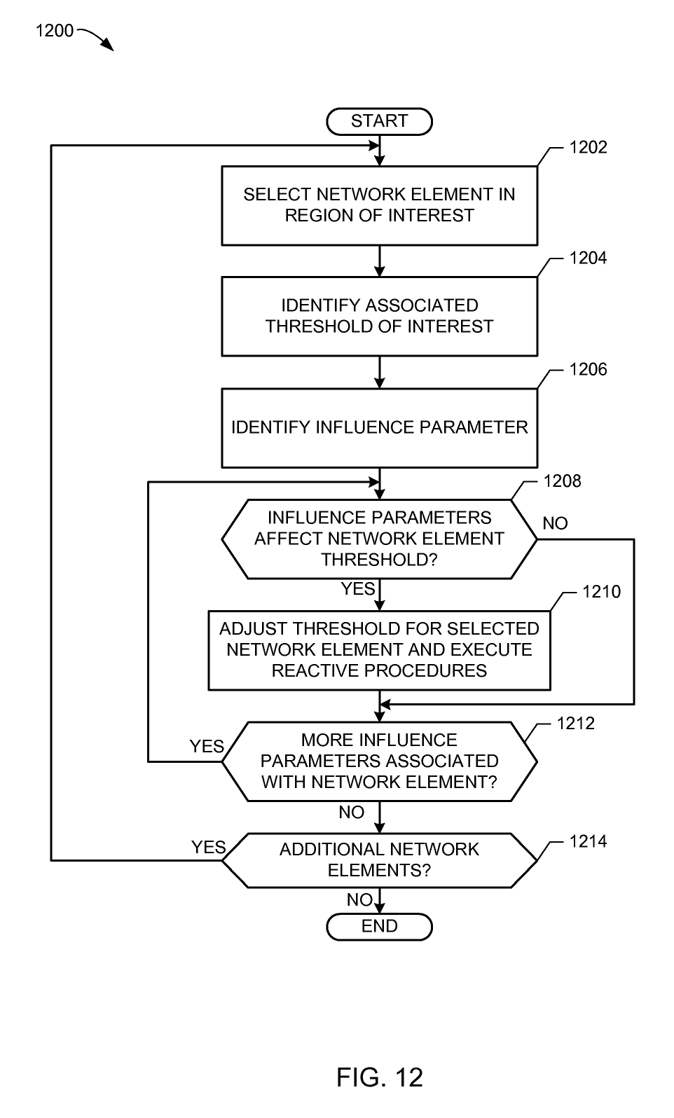

Turning to FIG. 12, an example influence-based analysis 1200 begins by the network correlator 226 selecting a network element of interest (block 1202) in the region of interest. One or more associated thresholds associated with one or more operating parameters of the network element are identified (block 1204). Operating parameters that may have corresponding thresholds include, but are not limited to, upload speeds, download speeds, latency values, and/or port availability values (e.g., 18 ports consumed out of 24 total ports=75% utilization). The example network correlator 226 queries the rule database 228 to determine whether one or more influence parameters are to be considered (block 1206). For example, a static threshold of port utilization may include an influence parameter related to an order rate, port performance values, etc. The example rule database 228 includes one or more lookup tables to identify whether the influence parameter affects the static threshold (block 1208) and, if so, the static threshold is adjusted based on the influence (block 1210). If the network element includes additional influence parameters (block 1212), then control returns to block 1208, otherwise control advances to block 1214 to determine whether additional network elements reside in the example region of interest to be analyzed. If so, then control returns to block 1202.

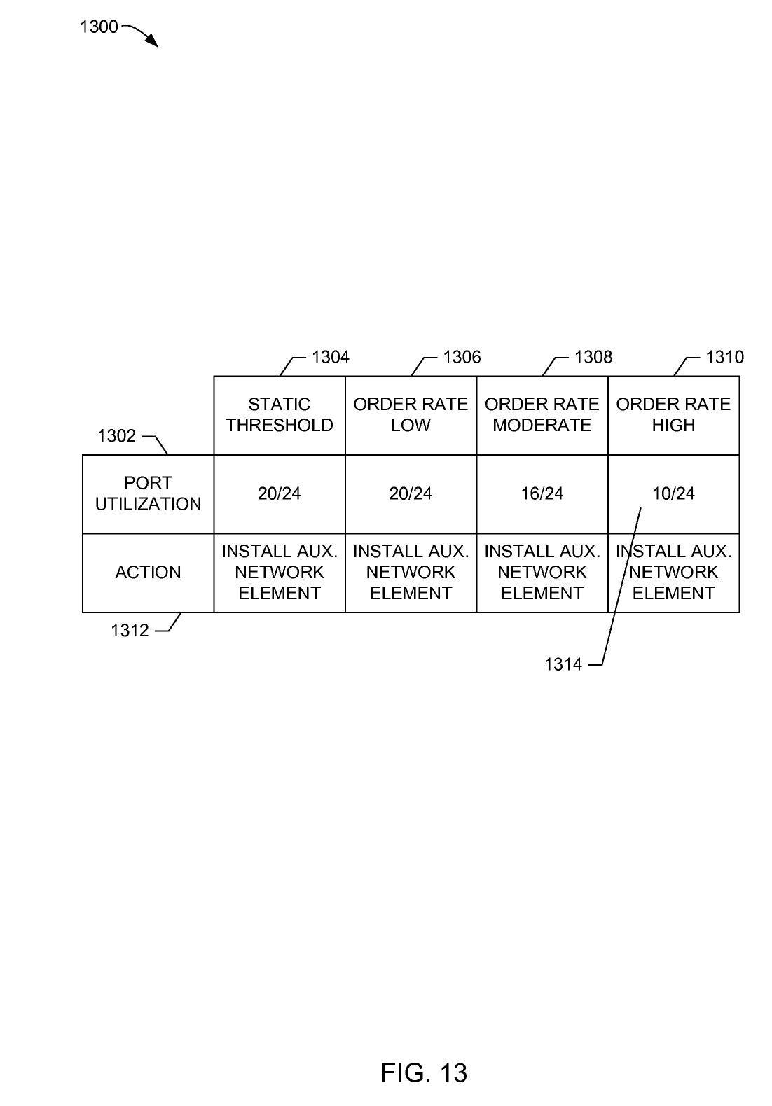

As described above, the example network correlator 226 may employ the rule database 228 to determine whether influence parameters affect and/or alter a given threshold associated with one or more operating parameters of the network element of interest. In the illustrated example of FIG. 13, an influence table 1300 identifies a port utilization parameter row 1302 to illustrate a static threshold 1304 and/or influence parameters 1306, 1308, and 1310. The example influence table 1300 also includes an associated action row 1312. Without considering influence thresholds, the example static threshold 1304 for the port utilization operating parameter is triggered after twenty out of twenty-four available ports are consumed, at which time the example network correlator 226 invokes an action 1312 message to install an auxiliary network element (e.g., an auxiliary DSLAM). However, the example influence table 1300 indicates that at least one additional influence parameter causes an influential threshold to be employed instead of the static threshold. For example, in the event that the order rate is high 1310 in the region of interest, then the threshold is invoked after only ten out of twenty-four ports become utilized 1314. While the illustrated example influence table 1300 of FIG. 13 includes a single type of influence metric (i.e., order rate) compared with the network element parameter (i.e., port utilization), any number of additional or alternate influence parameters may be combined in a compound fashion to generate one or more influence threshold values. For example, an influence threshold of average port performance (in kb/second) may be added to the table 1300 as an “AND” condition. As such, if one or more bandwidth thresholds are met/exceeded, the example network correlator 226 may invoke one or more alternate action(s).

FIG. 14 is a schematic diagram of an example processor platform P100 that may be used and/or programmed to implement any or all of the example port resource manager 154, the example region interface manager 202, the example regional data repository 204, the example capacity engineering database 206, the example workforce implementation database 208, the example network fault and performance database 210, the example order fulfillment database 212, the example marketing database 214, the example port/loop utilization tracker 216, the example order tracker 218, the example network performance tracker 220, the example workforce tracker 222, the example service call tracker 224, the example network correlator 226, and/or the example rule database 228 of FIGS. 1 and 2. For example, the processor platform P100 can be implemented by one or more general-purpose processors, processor cores, microcontrollers, etc.

The processor platform P100 of the example of FIG. 14 includes at least one general-purpose programmable processor P105. The processor P105 executes coded instructions P110 and/or P112 present in main memory of the processor P105 (for example, within a RAM P115 and/or a ROM P120). The processor P105 may be any type of processing unit, such as a processor core, a processor and/or a microcontroller. The processor P105 may execute, among other things, the example processes of FIGS. 4-12 to implement the example methods and apparatus described herein.

The processor P105 is in communication with the main memory (including a ROM P120 and/or the RAM P115) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. Access to the memory P115 and the memory P120 may be controlled by a memory controller (not shown). The example memory P115 maybe used to implement the example databases 128 and/or 130 of FIG. 1.

The processor platform P100 also includes an interface circuit P130. The interface circuit P130 may be implemented by any type of interface standard, such as an external memory interface, serial port, general-purpose input/output, etc. One or more input devices P135 and one or more output devices P140 are connected to the interface circuit P130.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method to implement a dynamic network element performance threshold, comprising:
receiving a static threshold associated with a network parameter;
receiving a current value associated with the network parameter;
invoking a first response when the current value exceeds the static threshold;
when the current value does not exceed the static threshold, receiving a second threshold associated with a rate of change value of the network parameter; and
invoking a second response when the rate of change value exceeds the second threshold.

2. A method as defined in claim 1, wherein the network parameter comprises a port utilization.

3. A method as defined in claim 1, wherein the network parameter comprises a data transfer speed.

4. A method as defined in claim 1, wherein the network parameter comprises a service call value.

5. A method as defined in claim 1, wherein the network parameter comprises a subscriber new order value.

6. A method as defined in claim 1, wherein the network parameter comprises at least one of a subscriber new order value or a subscriber disconnect value.

7. A method as defined in claim 1, wherein the first response comprises at least one of invoking a service call, replacing a network element, or installing an auxiliary network element.

8. A method as defined in claim 1, further comprising modifying an engineering plan based on the received rate of change value associated with the second threshold.

9. A method as defined in claim 8, wherein modifying the engineering plan comprises at least one of adjusting a quantity of network elements installed, adjusting a type of network element installed, or retrofitting an infrastructure topology.

10. A method as defined in claim 8, wherein the received rate of change value associated with the second threshold comprises a rate of network failures contributed to at least one of legacy network elements or a legacy infrastructure in the network region of interest.

11-13. (canceled)

14. A method to adjust a network element performance threshold, comprising:
receiving a static threshold associated with a network parameter of interest;
receiving a value associated with the network parameter of interest;
identifying at least one influence parameter associated with the network parameter;
receiving a network performance value associated with the at least one influence parameter; and
adjusting the static threshold based on the received network performance value.

15. A method as defined in claim 14, wherein the network parameter comprises a port utilization and the at least one influence parameter comprises a data transfer speed.

16. A method as defined in claim 14, wherein the network parameter comprises a port utilization and the at least one influence parameter comprises a service call value.

17. A method as defined in claim 14, wherein the network parameter comprises a port utilization and the at least one influence parameter comprises at least one of a new order value or an order disconnect value.

18-23. (canceled)

24. A method as defined in claim 14, further comprising comparing the received network performance value with an influence parameter threshold.

25. A method as defined in claim 24, further comprising adjusting the static threshold when a logical AND condition is satisfied between the influence parameter threshold, the received network performance value associated with the at least one influence parameter, and the value associated with the network parameter of interest.

26. An apparatus to manage network port resources, comprising:
a region interface manager to receive characteristic information from a plurality of network regions;
a regional data repository to store the received characteristic information;
at least one network tracker to measure and calculate at least one rate of change associated with the received characteristic information; and
a network correlator to implement a dynamic network element performance threshold based on the at least one rate of change.

27. (canceled)

28. An apparatus as defined in claim 26, wherein the at least one network tracker comprises a port tracker to measure network element port utilization at a plurality of different times.

29. An apparatus as defined in claim 28, wherein the port tracker calculates a rate of port utilization based on the measured plurality of different times.

30. An apparatus as defined in claim 26, wherein the at least one network tracker comprises an order tracker to measure at least one or new subscriber orders or existing subscriber disconnects at a plurality of different times.

31. An apparatus as defined in claim 30, wherein the order tracker calculates at least one of a rate of new subscriber orders based on the measured plurality of different times, or a rate of existing subscriber disconnects based on the measured plurality of different times.

32. An apparatus as defined in claim 26, wherein the at least one network tracker comprises a network performance tracker to measure at least one network element performance parameter at a plurality of different times.

33. An apparatus as defined in claim 32, wherein the network performance tracker calculates a rate of performance parameter change based on the measured plurality of different times.

34-41. (canceled)
